(19) United States
(12) Patent Application Publication
(10) Pub. No.: US 2006/0278841 A1
(43) Pub. Date: Dec. 14, 2006

(54) Door mounting structure for air conditioning system

(75) Inventors: Naoto Futami, Nukata-gun (JP); Takuya Natume, Kariya-city (JP); Yasuo Fukase, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/451,252

(22) Filed: Jun. 12, 2006

(30) Foreign Application Priority Data
Jun. 13, 2005 (JP) 2005-172681

(51) Int. Cl. F16K 1/22

(52) U.S. Cl. 251/305

(57) ABSTRACT

A door mounting structure for an air conditioning system is disclosed. An axial end portion (121B) of a door (120) arranged in a case (110) is journaled rotatably on a bearing portion (111B) of the case (110). The forward end of the bearing portion (121B) is inserted into the bearing portion (111B) in such a manner as to be projected out of the case (110). In order to secure a predetermined clearance between the bearing portion (111B) and the axial end portion (121B), the bore of the bearing portion (111B) is larger than the diameter of the axial end portion (121B). A fixing member (130) is inserted into the portion of the secured clearance and fixed on the axial end portion (121B) or the bearing portion (111B). The insertability of the axial end portion into the air-conditioning case is improved and a defect such as an insertion failure is prevented.

### BACKGROUND OF THE INVENTION

1. Field of the Invention

This invention relates to a mounting structure of an air conditioning system door journaled and rotated on an air-conditioning case to adjust the air-conditioning air flow suitably and applicable to, for example, an automotive air conditioning system.

2. Description of the Related Art

The conventional door for an air conditioning system is disclosed in, for example, Japanese Unexamined Patent Publication No. 2004-196168 in which an axial portion is journaled on a bearing portion of an air-conditioning case and the door is rotatably and axially movable. Specifically, as shown in FIGS. 4, 5, an air-conditioning case 110 is divided into two parts in axial direction of a door 120, and a bearing portion 111 (111A, 111B) has an axial hole in each of cases 110A, 110B. One axial end portion 121 (121A) of the door 120 is inserted into the bearing portion 111A of the air-conditioning case 110A. In assembling the other air-conditioning case 110B on the air-conditioning case 110A, the other axial end portion 121 (121B) is inserted into the bearing portion 111B of the other air-conditioning case 110B. An operation lever 136A for rotating the door is fixed on the exterior of the air-conditioning case 110 of the other axial end portion 121B.

In the door 120 disclosed in Japanese Unexamined Patent Publication No. 2004-196168, however, the clearance between the bearing portion 111 and the axial end portion 121 is set to the required minimum for rotation, and therefore the workability is low for insertion of the axial end portion 121 into the bearing portion 111 (especially, the workability is low for inserting the axial end portion 121B into the bearing portion 111B).

A measure against this has been taken by using a structure in which, as shown in FIG. 6, the axial end portion 121B is not inserted into the bearing portion 111B, but the operation lever 136A is used as a fixing member, and a fixed shaft 136B extending from the operation lever 136A is inserted into the bearing portion 111B from outside of the air-conditioning case 110B and fixed on the axial end portion 121B of the door 120. In this case, however, the axial end portion 121B is not easily visible from the outside of the air-conditioning case 110B and the assembly condition with the operation lever 136A cannot be visually checked. As shown in FIG. 7, therefore, an insertion failure of the operation lever 136A (fixed shaft 136B) can occur though not with a high probability.

### SUMMARY OF THE INVENTION

In view of the problem described above, the object of this invention is to provide a door mounting structure of an air conditioning system free of an assembly defect, such as an insertion failure, with an improved insertability of the axial end portion into the air-conditioning case.

In order to achieve this object, according to this invention, the following technical means are employed.

According to this invention, there is provided an air conditioning system door mounting structure, wherein the axial end portion (121B) of the door (120) arranged in the case (110) is rotatably journaled on the bearing portion (111B) of the case (110), wherein the forward end of the axial end portion (121B) is inserted into the bearing portion (111B) in such a manner as to be projected outside of the case (110) and, in order to secure a predetermined clearance between the bearing portion (111B) and the axial end portion (121B), the bore of the bearing portion (111B) is set larger than the diameter of the axial end portion (121B) and a fixing member (130) is fixed on the axial end portion (121B) or the bearing portion (111B) by being inserted into the secured clearance.

As a result, a predetermined clearance is secured between the bearing portion (111) and the axial end portion (121) and, therefore, the workability of inserting the axial end portion (121) into the bearing portion (111) is improved. Also, by guiding the axial end portion (121) projected out of the case (110), the fixing member (130) can be easily inserted into the secured clearance, and therefore an air conditioning system door structure free of an assembly failure is provided.

According to this invention, the fixing member (130) is also used as an operation lever (137) for giving the turning effort to the door (120) on the one hand and is fixed on the axial end portion (121B) at the same time.

Thus, both the door (120) and the fixing member (130) are rotated, and therefore the number of parts of the operation lever (137) as the fixing member (130) is reduced so that the door (120) can be rotated by the operation lever (137).

According to this invention, the cross section of the axial end portion (121B) perpendicular to the axial direction is noncircular and the fixing member (130) engages the noncircular form fixedly in the direction of axial rotation of the axial end portion (121B).

Thus, the axial end portion (121) and the fixing member (130) can be positively fixed in the direction of axial rotation, and therefore, with the fixing member (130) functioning as the operation lever (137), the turning effort can be positively transmitted to the axial end portion (121), i.e. the door (120).

According to this invention, the fixing member (130) includes an engaging portion (134) which, after being inserted into the secured clearance, elastically expands in the direction along the bore diameter of the bearing portion (111B) and engages the bearing portion (111B) in axial direction.

Thus, the fixing member (130) engages the bearing portion (111) axially simply by being inserted for an improved mountability.

According to this invention, the fixing member (130) is formed of a resin material

Thus, the fixing member (130) fixedly engaging the bearing portion (111) can be easily formed by effective utilization of the elastic deformation.

According to this invention, the fixing member (130) has a grip portion (136) adapt to be gripped by a robot hand.

Thus, the fixing member (130) can be easily assembled automatically using the robot hand.

According to this invention, a lubricating material is interposed between the bearing portion (111B) and the fixing member (130).

Thus, the rotation of the bearing portion (111) and the fixing member (130) is smooth, which in turn makes the rotation of the door (120) smooth.

According to this invention, the other axial end portion (121A) of the door is journaled rotatably on the other bearing portion (111A) of the case (110). Also, the bore of the bearing portion (111B) is larger than the bore of the other bearing portion (111A), and the two axial end portions are both projected outside of the case (110). Thus, the insertion of the axial end portion into the bearing portion can be easily checked and an insertion failure can be prevented.

The present invention may be more fully understood from the description of preferred embodiments of the invention, as set forth below, together with the accompanying drawings.

### BRIEF DESCRIPTION OF THE DRAWINGS

FIG. 1 is a sectional view showing an air-conditioning door mounted in an air-conditioning case of an air conditioning system.

FIG. 2 is an enlarged sectional view of portion A in FIG. 1.

FIG. 3 is a sectional view taken from direction B in FIG. 2.

FIG. 4 is a sectional view showing an air-conditioning door mounted in the air-conditioning case in the prior art.

FIG. 5 is an enlarged sectional view of portion G in FIG. 4.

FIG. 6 is a sectional view showing the mounting portion of the air-conditioning door mounted in the air-conditioning case in the prior art.

FIG. 7 is a sectional view showing an insertion failure of the fixed shaft in FIG. 6.

### DESCRIPTION OF THE PREFERRED EMBODIMENTS

### First Embodiment

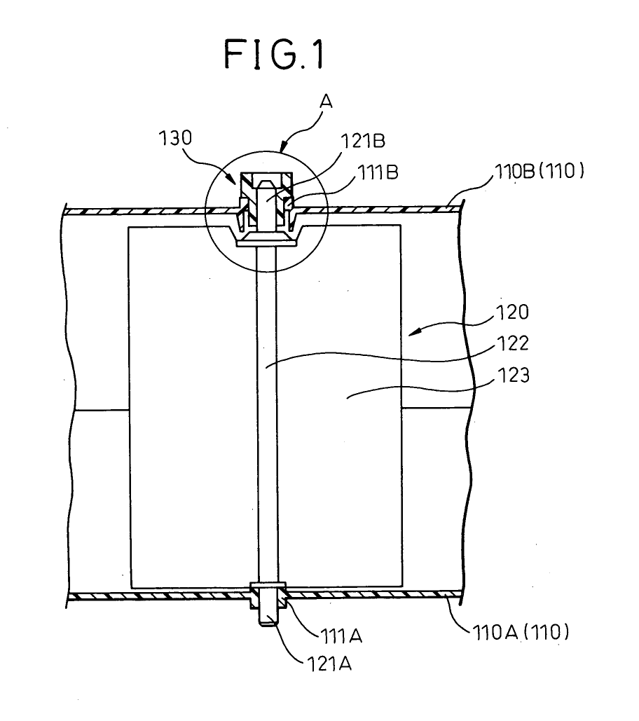

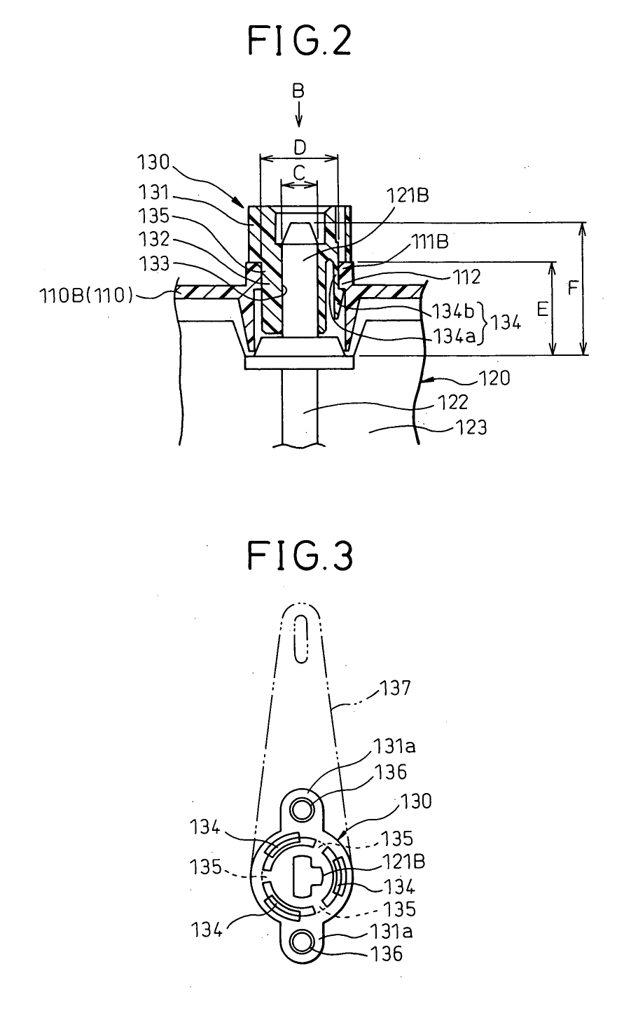

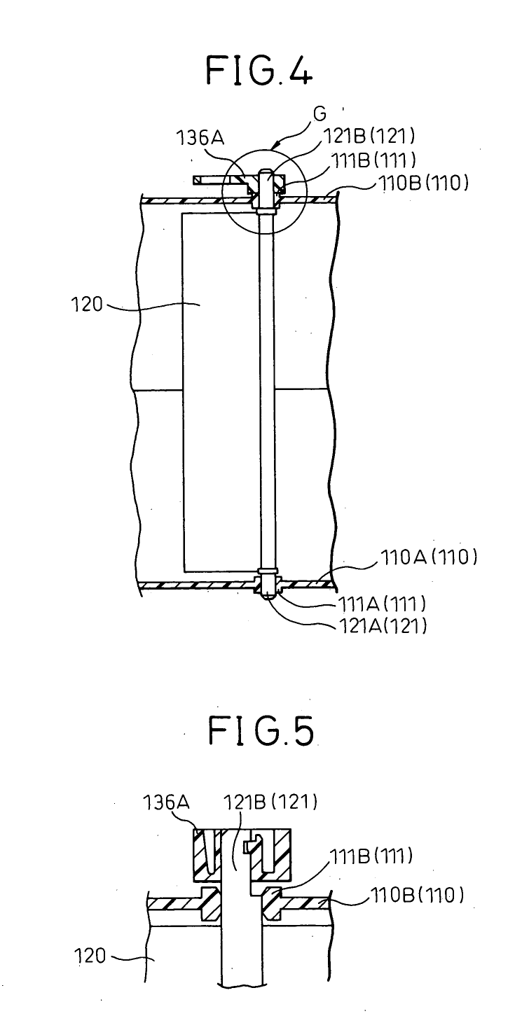

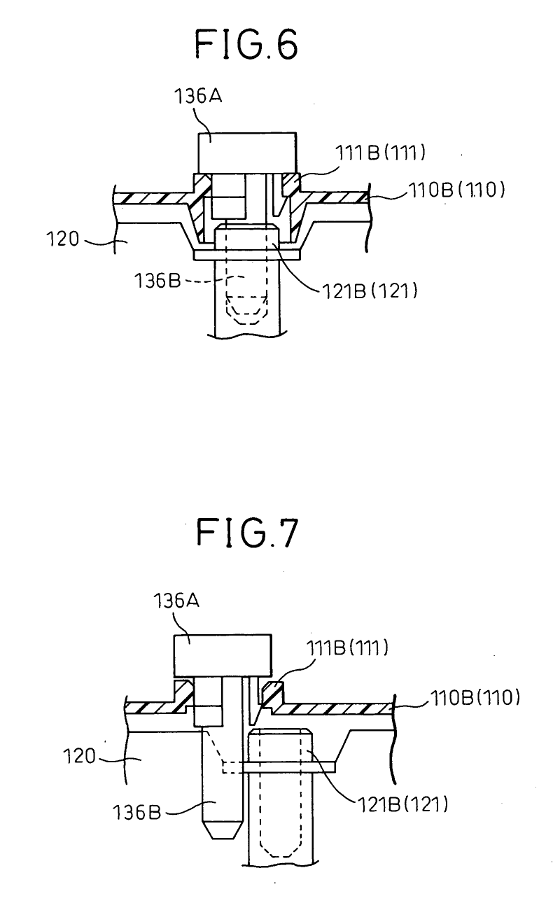

A first embodiment of the invention is explained with reference to FIGS. 1 to 3. The first embodiment is an application of the door mounting structure for the air conditioning system according to the invention to an automotive air conditioning system. FIG. 1 is a sectional view showing an air-conditioning door 120 mounted in an air-conditioning case 110 of the air conditioning system, FIG. 2 being an enlarged sectional view of the portion A in FIG. 1, and FIG. 3 being a sectional view taken from the direction B in FIG. 2.

The automotive air conditioning system (not shown) includes a blow unit for blowing air by introducing internal or external air selectively as an air-conditioning air, and an air-conditioning unit for cooling and heating the air-conditioning air from the blow unit through a cooling heat exchanger and a heating heat exchanger, respectively, and blowing out from a selected air outlet. The air-conditioning case (corresponding to the case according to the invention) 110 makes up an external case of each unit and leads the air-conditioning air from the blow unit toward the air-conditioning unit.

In the air-conditioning unit 110, the most upstream portion of the blow unit, the heat exchanger and the outlet portion of the air-conditioning unit have a plurality of air-conditioning doors (corresponding to the door according to the invention) 120 journaled rotatably on the air-conditioning case 110. According to the rotational position of each air-conditioning door 120 rotated, the internal or external air in the most upstream portion is selected, the mixing ratio of the air-conditioning air cooled or heated by the heat exchanger is adjusted and further, the air outlet of the outlet portion is selected.

The structure for mounting the air-conditioning doors 120 on the air-conditioning case 110 is explained in detail below.

The air-conditioning doors 120 are each formed of a resin material, and a door shaft 122 and a tabular door portion 123 are formed integrally with each other. The two forward end portions of the door shaft 122 are extended and projected from the axial end portions of the door portion 123 and form axial end portions 121A, 121B. The cross section of the axial end portion 121B perpendicular to the axial direction is noncircular, or specifically formed in the shape of T (FIG. 3).

The air-conditioning case 110, on the other hand, is formed by injection molding of a resin material (such as polypropylene). The air-conditioning case 110 is divided into two parts along the direction of the door shaft 122 of the air-conditioning door 120, and the case divisions make up an air-conditioning case 110A and an air-conditioning case 110B, respectively. At the position of each of the air-conditioning cases 110A, 110B for setting the air-conditioning door 120, bearing portions 111A, 111B having holes into which the axial end portions 121A, 121B of the air-conditioning door 120 are adapted to be inserted are formed.

The bore of the bearing portion 111A is substantially equal to the axial diameter of the axial end portion 121A, and is of such a size that the axial end portion 121A can be inserted and rotated. The bore (D in FIG. 2) of the bearing portion 111B, on the other hand, is larger than the axial diameter (C in FIG. 2) of the axial end portion 121B in such a manner that the axial end portion 121B can be easily inserted into the bearing portion 111B at the time of assembling the air-conditioning case 110B and the air-conditioning door 120 described later, i.e. in such a manner that the gap (corresponding to the predetermined clearance in this invention) formed between the bearing portion 111B and the axial end portion 121B is sufficiently large. The bore of the bearing portion 111B is larger inside the air-conditioning case 110B, and a step 112 is formed, by the bore difference, in the bearing portion 111B.

The axial end portions 121A, 121B each have the forward end adapted to be projected outside of the bearing portions 111A, 111B, respectively, when assembled on the air-conditioning case 110. Specifically, in FIG. 2, the size F from the axial end of the door portion 123 to the forward end of the axial end portion 121B is larger than the size E from the axial end portion of the door portion 123 to the outer end of the bearing portion 111B.

A fixing plate 130 is fixed as a fixing member on the axial end portion 121B. The fixing plate 130 is formed of a resin material and includes a cylindrical head portion 131 formed with a central through hole 133 and an insert portion 132 having a smaller diameter than the head portion 131. The through hole 133 of the insert portion 132 is in the shape of T so that the axial end portion 121B having a T-shaped cross section can be inserted. The through hole 133 of the head portion 131 is in the shape of a circle larger than the outermost diameter of the axial end portion 121B.

A plurality of (three, for example) engaging portions 134 each including a tabular portion 134a and a hook portion 134b are arranged integrally along the outer periphery of the insert portion 132. The tabular portion 134a is thin, has an arcuate cross section and is formed to extend from the bearing portion 111B of the head portion 131 toward the air-conditioning door 120. The tabular portion 134a is arranged at a distance of more than the projection of the hook 134b from the outer peripheral surface of the insert portion 132. The hook portion 134b is projected toward the outer diameter of the insert portion 132 by a size increased progressively from the forward end thereof toward the head portion 131.

The tabular portion 134a is adapted be deformed elastically diametrically of the insert portion 132, and at the time of assembling the fixing plate 130 described later, displaced toward the diametrical center of the insert portion 132. After assembly, the tabular portion 134a returns diametrically outward, so that the hook portion 134b engages the step 112 of the bearing portion 111B.

Also, between the plurality of the engaging portions 134 on the outer periphery of the insert portion 132, a plurality of guide portions 135 having an arcuate surface extend to the air-conditioning door 120 from the bearing portion 111B of the head portion 131. An outer arcuate surface of a plurality of tabular portions 134a and guide portions 135 is arranged to make up a part of a common circle, the diameter of which corresponds to the bore D of the bearing portion 111B.

Two expansions 131a in opposed relation to each other are formed on the outer periphery of the head portion 131. Each expansion 131a has a chuck hole (corresponding to the grip according to the invention) 136 cut through in axial direction to chuck the fixing plate 130 with an automatic assembly robot hand (not shown). Also, the head portion 131 is formed integrally with an operation lever 137 extending radially outward and coupled to a link mechanism or a wire for driving the air-conditioning door 120.

Next, a method of assembling the air-conditioning door 120 on the air-conditioning case 110 will be briefly explained. The assembly work is assumed to be conducted manually by a worker.

First, the axial end portion 121A of the air-conditioning door 120 is inserted into the bearing portion 111A of the air-conditioning case 110A. The air-conditioning case 110B is set on the air-conditioning case 110A. In the process, the axial end portion 121B of the air-conditioning door 120 is inserted into the bearing portion 111B (hole) of the air-conditioning case 110B, while at the same time the two air-conditioning cases 110A, 110B are assembled.

The outside surfaces of the guide portion 135 and the engaging portion 134 of the fixing plate 130 are coated with grease (corresponding to the lubricating material according to the invention), and the fixing plate 130 is mounted on the axial end portion 121B projected from the bearing portion 111B. In mounting the fixing plate 130, the T-shaped cross section of the axial end portion 121B is set the same direction as the T-shaped through hole 133 of the fixing plate 130, and the fixing plate 130 is forced into the door portion 123 from the forward end of the axial end portion 121B.

In this way, the guide portion 135 and the engaging portion 134 of the fixing plate 130 proceed into the gap (the gap (D−C)/2 according to this embodiment) formed between the bearing portion 111B and the axial end portion 121B. Specifically, the tabular portion 134a of the engaging portion 134 is displaced toward the diametrical center of the insert portion 132 and the hook portion 134b moves while in contact with the hole of the bearing portion 111B. Also, the outer peripheral surface of the guide portion 135 moves while being substantially in contact with the hole of the bearing portion 111B. Once the hook portion 134b reaches the step portion 112 of the bearing portion 111B, the displacement of the tabular portion 134a returns diametrically outward, and the hook portion 134b comes to engage the step portion 112. As a result, the fixing plate 130 is fixedly engaged along the axis of the axial end portion 121B. Also, the engagement between the T-shaped cross section of the axial end portion 121B and the T-shaped through hole 133 of the fixing plate 130 causes the fixing plate 130 to engage the axial end portion 121B in the direction of axis rotation. As a result, the fixing plate 130 is fixed on the axial end portion 121B (i.e. the air-conditioning door 120), while at the same time being set rotatable with respect to the bearing portion 111B. Incidentally, the grease coated on the engaging portion 134 and the guide portion 135 intrudes into the gap between the bearing portion 111B and the hole.

As described above, in the door mounting structure for the air conditioning system according to this embodiment, the bore D of the bearing portion 111B is set larger than the axial diameter C of the axial end portion 121B, so that the gap between the bearing portion 111B and the axial end portion 121B is sufficiently large, and therefore the workability of inserting the axial end portion 121B into the bearing portion 111B is improved.

Also, the fixing plate is mounted on the axial end portion 121B so that the guide portion 135 and the engaging portion 134 of the fixing plate 130 can be inserted into the gap with the axial end portion 121B projected out of the air-conditioning case 110B as a guide. Therefore, positive assembly work is possible and is free of an assembly failure. Even in the case where an assembly failure occurs, the assembly condition of the axial end portion 121B and the fixing plate 130 can be positively determined by visual check from direction B in FIG. 2. As a result, this inspection process prevents any defective products from being produced.

Also, in view of the fact that the operation lever 137 is integrally formed on the fixing plate 130 and the fixing plate 130 is fixed on the axial end portion 121B, the number of parts can be reduced by the fixing plate 130 doubling as the operation lever 130 so that the air-conditioning door 120 can be rotated by the operation lever 137.

In fixing the fixing plate 130 on the axial end portion 121B, the cross section of the axial end portion 121B is formed as noncircular to engage the through hole 133 of the fixing plate 130. Therefore, the axial end portion 121B and the fixing plate 130 can be positively fixed in the direction of axis rotation, and the turning effort can be positively transmitted from the operation lever 137 and the fixing plate 130 to the axial end portion 121B, i.e. the air-conditioning door 120.

Also, the provision of the engaging portion 134 on the fixing plate 130 makes it possible for the fixing plate 130 to engage the bearing portion 111 in axial direction simply by inserting the fixing plate 130 into the axial end portion 121B. Thus, the assembly efficiency is improved (one-touch assembly).

The fixing plate 130 is formed of resin, and therefore can engage the bearing portion 111B effectively utilizing the elastic deformation of the engaging portion 134.

In view of the fact that grease is interposed between the bearing portion 11B and the fixing plate 130, the bearing portion 111B and the fixing plate 130 rotate smoothly, which in turn makes the smooth rotation of the air-conditioning door 120 possible.

### Other Embodiments

In the first embodiment described above, the fixing plate 130 is mounted on the axial end portion 121B manually by the worker. As an alternative, a robot may be used for assembly through the chuck hole 136 of the fixing plate 130.

Specifically, an assembly robot hand has two parallel extending rod-like portions with a changeable distance therebetween. A predetermined number of fixing plates 130 are aligned beforehand in the same direction on a pallet. Also, grease is prepared in a predetermined container.

First, the robot hand is moved to the pallet position of the fixing plate 130, and the rod-like portions are inserted into the chuck holes 136 and opened thereby chuck the fixing plate 130. Next, the robot hand is moved to the position of the grease container, the fixing plate 130 chucked is placed in the grease container, and grease is coated on the engaging portion 134 and the guide portion 135.

Further, the robot hand is moved so that the axial line of the axial end portion 121B is aligned with the axial line of the through hole 133 of the fixing plate 130, after which the fixing plate 130 is inserted into the axial end portion 121B. Upon complete insertion, the distance between the rod-like portions of the robot hand is narrowed to the pitch of the chuck holes 136, and the robot hand is separated from the fixing plate 130. This process is repeated.

By providing the chuck holes 136 of the fixing plate 130 capable of being gripped by the robot hand in this way, the robot assembly work (automatic assembly work) can be easily conducted.

According to the first embodiment described above, the fixing plate 130 is fixed on the axial end portion 121B. As an alternative, the fixing plate 130 may be fixed on the bearing portion 111B so that the axial end portion 121B (air-conditioning door 120) may be rotated with respect to the fixing plate 130. In this case, the operation lever 137, if provided, is connected to the axial end portion 121B.

Also, instead of forming the axial end portion 121B and the through hole 133 having a T-shaped cross section to assure engagement between the axial end portion 121B and the fixing plate 130, various other shapes including a polygon, a gear shape or a noncircular form may alternatively be employed.

Further, the fixing plate 130 may be formed of a material (metal, etc.) other than resin. Especially, a spring plate can be used to give elasticity to the engaging portion 134.

Furthermore, the door mounting structure for the air conditioning system according to this invention may be used also for the air conditioning systems in fields other than automobiles as long as a door is internally journaled and rotated.

While the invention has been described by reference to specific embodiments chosen for purposes of illustration, it should be apparent that numerous modifications could be made thereto, by those skilled in the art, without departing from the basic concept and scope of the invention.

1. A door mounting structure for an air conditioning system in which at least one axial end portion of a door arranged inside a case is rotatably journaled on a first bearing portion of the case,
wherein the forward end of the axial end portion is inserted into the bearing portion in such a manner as to be projected out of the case;
wherein the bore of the bearing portion is larger than the diameter of the axial end portion to secure a predetermined clearance between the bearing portion and the axial end portion; and
wherein a fixing member is inserted into the clearance from outside of the case and fixed on selected one of the axial end portion and the bearing portion.

2. A door mounting structure for an air conditioning system according to claim 1,
wherein the fixing member is also used as an operation lever for giving the turning effort to the door from outside of the case and the fixing member is fixed on the axial end portion.

3. A door mounting structure for an air conditioning system according to claim 2,
wherein the cross section of the axial end portion perpendicular to the axial direction is noncircular, and the fixing member engages the noncircular cross section fixedly on the axial end portion in the direction of axis rotation.

4. A door mounting structure for an air conditioning system according to claim 2,
wherein the fixing member includes an engaging portion which, after being inserted into the portion of the securing clearance, can be expanded, due to its elasticity, along the diametrical direction of the bore of the bearing portion and engages the bearing portion in axial direction.

5. A door mounting structure for an air conditioning system according to claim 4,
wherein the fixing member is formed of a resin molded part.

6. A door mounting structure for an air conditioning system according to claim 1,
wherein the fixing member includes a grip having a pair of chuck holes adapted to be gripped by a robot hand.

7. A door mounting structure for an air conditioning system according to claim 2,
wherein a lubricating material is interposed between the bearing portion and the fixing member.

8. A door mounting structure for an air conditioning system according to claim 1,
wherein the second axial end of the door is rotatably journaled on the second bearing portion of the case, the bore of the first bearing portion is larger than the bore of the second bearing portion, and both the first and second axial end portions are projected out of the case.
